(19) United States
(12) Patent Application Publication
(10) Pub. No.: US 2019/0111506 A1
(43) Pub. Date: Apr. 18, 2019

(54) GEAR MACHINING DEVICE WITH CENTERING DEVICE

(71) Applicant: REISHAUER AG, Wallisellen (CH)

(72) Inventors: Erwin SENNHAUSER, Kleinandelfingen (CH); Roman FURDERER, Istighofen (CH)

(73) Assignee: REISHAUER AG, Wallisellen (CH)

(21) Appl. No.: 16/096,729

(22) PCT Filed: Apr. 10, 2017
(86) PCT No.: PCT/EP2017/058515

§ 371 Date: Oct. 26, 2018

(30) Foreign Application Priority Data
May 9, 2016 (CH) 00601/16

(51) Int. Cl. B23F 23/12; B23F 23/04; G01M 13/021; G05B 19/18

(52) U.S. Cl. CPC B23F 23/1218; B23F 23/04; G05B 2219/36198; G01M 13/021; G05B 19/186; B23F 23/1293

(57) ABSTRACT

The invention relates to a device for machining workpieces with precut teeth; having a workpiece support and at least one workpiece spindle arranged on the workpiece support for clamping a workpiece (8). A centering device (20.1) for the workpieces comprises a probe holder (30) with a centering probe (26), which operates in a contactless manner, and a base element (37). The probe holder is connected to the base element such that the probe holder has a variable radial distance to the workpiece spindle axis. The base element is designed as a slide which can be moved relative to the workpiece support. A linear guide for the base element allows a movement of the base element relative to the workpiece support. An adjustment drive for the centering device can be arranged above the centering device on a backrest of the workpiece support.

### TECHNICAL FIELD

The present invention relates to a machine for machining workpieces with pre-machined teeth, in particular gears, comprising a meshing device for the workpieces.

### PRIOR ART

During the fine machining of pre-machined gears, it is necessary before the start of each machining operation for the tool and the gear to be machined to be arranged relative to one another such that the tool can move into the tooth space of the gear without a collision occurring. This procedure is referred to in the technical field as “meshing”.

A meshing operation is necessary in particular in the case of rolling-contact machining processes performed in continuous fashion. In the case of such processes, the gear to be machined is placed in engagement with a helical tool and is machined by rolling-contact coupling with the tool. In the case of modern NC-controlled machines, the gear to be machined (workpiece) is for this purpose chucked on an NC-controlled workpiece spindle which is driven in rotation. The tool is chucked on a likewise NC-controlled tool spindle which is driven in rotation. The rolling-contact coupling between tool spindle and workpiece spindle is then produced electronically by means of the NC control.

In the case of such rolling-contact machining processes, the tooth gap on the workpiece must be positioned relative to the thread turns of the helical tool. By means of the meshing operation, the rolling-contact coupling angle between the gear and the helical tool is defined.

Historically, for a long time, meshing was performed by hand and when the workpiece and tool were stationary. The rolling-contact coupling angle was in this case defined purely mechanically. This procedure was however highly time-consuming and susceptible to errors, and led to long non-productive idle times.

Consequently, there have firstly been various approaches to automate the meshing process. Secondly, methods have been developed which permit meshing without the imperative need for the tool spindle to be stopped. Nowadays, for the meshing process, use is commonly made of contactless probes which operate on an inductive or capacitive basis and which measure tooth flanks as the workpiece rotates. The rolling-contact coupling angle is defined electronically on the basis of such a contactless measurement.

Such a method is known for example from DE 36 15 365 C1. In this method, the gear to be machined is set in rotation, and the phase position of signals generated when the teeth of the gear pass a fixed probe is determined. This phase position is compared with the phase position that has been determined in a reference measurement using a gear of known orientation. The rolling-contact coupling angle between workpiece and tool is set in accordance with the difference between these phase positions.

In the case of meshing probes which operate in contactless fashion, a first objective is to position the meshing probe in the direct vicinity of the outer contour of the workpiece. Secondly, collisions between the meshing probe and a workpiece loading device during a workpiece change must be avoided.

In U.S. Pat. No. 6,577,917 B1, it is proposed that the meshing probe be attached to a probe holder. The probe holder is movable parallel to the workpiece spindle axis by means of an NC-controlled spindle. To be able to move the meshing probe out of the workpiece region during the workpiece change, the probe holder is furthermore pivotable by pneumatic or motor means about the axis of the spindle assigned thereto. The meshing probe itself is held on an adapter which is connected to the probe holder by means of a probe tube running perpendicular to the workpiece spindle axis. To adapt the position of the meshing probe to different workpiece diameters, the probe tube is displaced manually along its longitudinal direction relative to the probe holder.

In U.S. Pat. No. 7,013,744 B2, the meshing probe is arranged on a probe holder which forms an element of a double parallelogram guide. The parallelogram guide comprises a base element which is situated opposite the probe holder and which is rigidly connected to the machine bed or to a workpiece spindle housing. In this way, the meshing probe can be pivoted out of the workpiece region as required. The pivoting drive is arranged directly adjacent to the base element on the machine bed. The meshing probe is formed as a cylindrical rod. Said meshing probe is arranged so as to be displaceable along its own longitudinal axis, and clampable, in a holding column. The holding column is in turn arranged so as to be displaceable at right angles to the longitudinal axis of the probe, and clampable, in the probe holder. To adapt the position of the meshing probe to different workpiece diameters, the meshing probe is displaced along its longitudinal axis in the holding column and clamped. To adjust the position along the workpiece axis, the holding column is displaced in the probe holder and is clamped. The adjustment of the meshing probe is thus always performed relative to the holder, and purely manually.

WO 00/35621 A1 discloses a device for machining workpieces with pre-machined teeth, wherein two workpiece spindles are arranged on a common workpiece support in the form of a rotary plate. The workpiece machining is performed on one of the workpiece spindles while the workpiece change and the meshing operation are performed on the second workpiece spindle. The meshing operation is thus performed in parallel with the workpiece machining. Between the machining processes, the rotary plate is rotated, such that the positions of the two workpiece spindles are interchanged. Two meshing probes are situated on the rotary plate, wherein each of these meshing probes is assigned to a workpiece spindle. Provision is not made for an automatic adjustment of the probe position. The operator must therefore always manually position both probes during the batch change.

### SUMMARY OF THE INVENTION

It is an object of the present invention to specify a machine with a meshing device wherein a simple adjustment of the meshing device is possible.

Said object is achieved by means of a machine as claimed in claim 1. Further embodiments are specified in the dependent claims.

A machine for machining workpieces with pre-machined teeth is thus specified, which machine comprises:
a workpiece support;
at least one workpiece spindle for the chucking of a workpiece, the workpiece spindle being arranged on the workpiece support being adapted to be driven in rotation about a workpiece spindle axis; and
a meshing device.

The meshing device comprises a probe holder with a meshing probe for contactless operation, and a base element. The probe holder is connected to the base element so as to have a variable radial spacing to the workpiece spindle axis. For this purpose, the probe holder may in particular be connected to the base element so as to be pivotable relative to the base element along a curved path without changing its orientation. In particular, the meshing device may comprise at least two rockers which articulatedly connect the probe holder to the base element and which, together with the probe holder and the base element, form a parallelogram guide. Other mechanisms are however also conceivable for adjusting the probe holder radially with respect to the workpiece spindle axis, for example a radial linear guide between base element and probe holder.

To permit a simple adjustment of the meshing device even in the case of very restricted space conditions, the base element is formed as a slide which is movable relative to the workpiece support, and the device comprises an (axial) linear guide for the base element in order to permit a displacement of the base element relative to the workpiece support parallel to the workpiece spindle axis.

In this way, it is possible in a very simple manner for the entire meshing device to be displaced axially (that is to say parallel to the workpiece spindle axis) in order to position the meshing probe as a whole both radially and axially relative to the workpiece spindle axis or relative to the workpiece. At the same time, such an arrangement composed of slide and linear guide takes up only little space. It can readily be arranged in a region which cannot collide with a loading device. In the case of a pivotable workpiece support, this may be in particular a central region close to the pivot axis of the workpiece support. The proposed adjustable meshing device is suitable in particular for being automatically adjusted by one or more drives. In this way, an axial and/or radial adjustment can be made possible even during the workpiece machining process. The drives for the automatic radial and axial adjustment can be arranged remote from the meshing device. In particular if the workpiece spindle axis stands vertically in space, the drives can for example be arranged above the meshing device, where they do not pose an obstruction either during the machining process or during the workpiece loading process. Automatic drives are particularly advantageous if a radial and vertical adjustment of the meshing probe is necessary during automatic operation. For example, gauging and monitoring processes, but also the grinding of block gears with accurate angular positioning of the individual toothings, require automatic probe adjustments.

In preferred embodiments, the workpiece spindle axis runs vertically in space. The workpiece support may comprise a counter stand. The counter stand may in particular bear a tailstock for the workpiece spindle; in the present context, however, a counter stand is to be understood to mean any structure which forms a (preferably rigid) part of the workpiece support and extends vertically into a region above the meshing device. In this case, it is advantageous if the first and/or second adjustment drive are arranged on the counter stand above the meshing device. In this way, the drives are arranged at a position at which they do not pose an obstruction either during the machining process or during the workpiece change. Furthermore, sufficient space for the relatively large drives is available on the counter stand.

Whereas the invention is particularly well-suited to a vertical orientation of the workpiece spindle axis, embodiments are however in principle also conceivable in which the workpiece spindle axis runs horizontally in space.

If the probe holder comprises a parallelogram guide between the base element and the probe holder, the parallel joint axes at which the rockers, the base element and the probe holder are articulatedly connected to one another form, in a projection into a plane perpendicular to said joint axes, the corner points of a parallelogram. In this way, the probe holder is pivotable relative to the base element in constant orientation along the curved path in a pivot plane extending perpendicular to the joint axes.

This pivot plane extends preferably parallel to the workpiece spindle axis, or comprises said workpiece spindle axis. If the workpiece spindle axis is arranged vertically in space, this means that the probe holder is pivotable in a likewise vertically extending plane. In this way, it is firstly the case that the space requirement is additionally kept small. Secondly, in this way, the angular position of the meshing probe relative to the workpiece is maintained during the pivoting movement, such that possible meshing errors are avoided.

The displacement of the meshing device parallel to the workpiece spindle axis may basically take place manually or in motor-driven fashion. For this purpose, the machine may comprise a first pull rod which is connected to the base element and which extends parallel to the workpiece spindle axis. By means of the pull rod, the base element can be displaced relative to the workpiece support parallel to the workpiece spindle axis.

For the guidance of the base element, the machine may comprise rollers which are arranged to both sides of the first pull rod and between which the first tension rod is longitudinally guided. In this case, the first pull rod and the rollers may together form the linear guide for the base element, or form a part of said linear guide.

To improve the guidance of the base element, the machine may comprise a guide plate which is arranged on the workpiece support and which defines a guide surface running parallel to the workpiece spindle axis. The base element may then have a slide surface which is complementary to the guide surface and which slides in displaceable fashion on the guide surface in order to form a sliding guide for the base element. To additionally stabilize the meshing device during the meshing process, a suction opening may be provided in the slide surface, which suction opening serves for fixing of the base element to the guide plate by means of negative pressure. For this purpose, the machine may comprise a suction device, for example in the form of a vacuum pump, which is connectable to the suction opening in order to generate negative pressure at the suction opening. Through the application of positive pressure at the suction opening, it is then possible for such fixing to be readily released again in order to adjust the meshing device. Correspondingly, the machine may comprise a compressed-air source which is connectable to the suction opening in order to generate positive pressure at the suction opening. A line which opens out in the suction opening may be selectively switchable between the suction device and the compressed-air source.

As already mentioned, the adjustment may be realized in motor-driven fashion, in particular by means of an NC axis. For this purpose, the machine may comprise a first adjustment drive, in particular an NC-controlled servo motor. Furthermore, the machine may comprise a threaded spindle which interacts with the first adjustment drive, which extends parallel to the workpiece spindle axis, and which is connected directly or indirectly to the base element such that an actuation of the first adjustment drive effects a displacement of the base element parallel to the workpiece spindle axis.

In one advantageous embodiment, the adjustment mechanism is designed as follows: the machine comprises a tubular first pull rod which is connected to the base element and which extends parallel to the workpiece spindle axis. The threaded spindle extends axially into the interior of the tubular first pull rod. The machine furthermore comprises a nut which is rigidly connected to the first pull rod and which interacts with the threaded spindle in order to effect, as a result of a rotation of the threaded spindle, a displacement of the pull rod (and thus also of the base element) parallel to the workpiece spindle axis. The threaded spindle can be driven in rotation by the first adjustment drive.

Other embodiments are however also conceivable, for example an embodiment in which the first adjustment drive drives a nut for the threaded spindle in rotation, and the threaded spindle is rotationally fixed and axially displaceable. However, such an arrangement requires more space, because the threaded spindle, in its upper end position, may under some circumstances project to a very great extent above the adjustment drive.

To adapt the position of the meshing probe radially to different workpiece diameters, a drive shaft may be provided which extends parallel to the workpiece spindle axis and which is rotatable relative to the base element. A gearing may then be provided on the base element in order to convert a rotational movement of the drive shaft into a movement which effects a change of the radial spacing of the probe holder from the workpiece spindle axis. In particular if the probe holder is pivotably connected to the base element, for example by means of the parallelogram guide already mentioned, the gearing can convert the rotational movement into a pivoting movement of the probe holder. The gearing may for example comprise a worm or a pinion on the drive shaft and an output wheel which interacts with the worm or the pinion. The output wheel may then be rigidly connected to one of the rockers of the parallelogram guide, or act on one or more rockers in some other way. However, of course other gearing arrangements may be employed as well.

A gearing as mentioned generally exhibits play with regard to the pivoting direction, which arises from the fact that the tooth flanks of the toothed gearing elements (such as worm or pinion and output wheel) may bear against one another at two opposite flanks depending on the load direction. To avoid the play caused by a flank change, the machine may comprise a spring which generates a counter-load in the form of a resetting force or a resetting torque, wherein said counter-load ensures that the toothed gearing elements always bear against the same flanks during operation of the gearing. The spring force may act in addition to the weight force of the moving parts, and thus assist the action of the weight force. The spring thus, by means of the counter-load that it generates, possibly in interaction with the weight force of the moving parts, prevents a flank change in the gearing. The spring may in particular be a compression or tension spring, preferably a gas spring, which is arranged between the base element and the probe holder. In the case of a parallelogram guide, the spring is preferably arranged within the pivot plane diagonally with respect to the parallelogram guide, such that the spring changes its length during the pivoting of the parallelogram guide. In particular, the spring may be arranged diagonally between the joint axes of the parallelogram guide.

The drive shaft may be manually rotatable, or may be motor-driven, in particular by means of an NC axis. For this purpose, the machine may comprise a second adjustment drive, in particular an NC-controlled servo motor. To transmit the rotational movement of the second adjustment drive to the drive shaft, the machine may combine a spline shaft which can be driven by the second adjustment drive so as to perform a rotational movement about its longitudinal axis and which extends parallel to the workpiece spindle axis. The machine may then furthermore comprise a spline hub which is connected to the drive shaft and which engages in longitudinally displaceable and rotationally conjoint fashion with the spline shaft in order to transmit a rotational movement of the second adjustment drive to the drive shaft. By virtue of the spline hub being displaceable axially on the spline shaft, it is possible for a torque to be transmitted in a very precise manner while changes in the axial spacing between the second adjustment drive and the base element can be compensated.

In an alternative embodiment, the pivoting movement of the probe holder is effected by means of a lever mechanism which is actuated by means of a second pull rod. For this purpose, the machine comprises a second pull rod which extends parallel to the workpiece spindle axis and which is axially displaceable relative to the base element. The machine furthermore comprises a lever mechanism which connects the second pull rod to the meshing device such that an axial displacement of the pull rod relative to the base element effects a change of the radial spacing of the probe holder from the workpiece spindle axis. For this purpose, the lever mechanism may comprise a pivotable lever arm which connects the probe holder and the base element and which is engaged on in between by the second pull rod. The pull rod may be connected to the lever arm by means of a pivotable intermediate piece as compensating element in order to compensate the curved movement of the lever arm.

The actuation of the second pull rod may be realized by motor means, in particular by means of an NC axis. For this purpose, the machine may comprise a second adjustment drive, in particular an NC-controlled servo motor, which interacts with a second threaded spindle. Said second threaded spindle then extends parallel to the workpiece spindle axis and is connected to the second pull rod such that an actuation of the second adjustment drive effects a displacement of the second pull rod parallel to the workpiece spindle axis.

In a yet further embodiment, the machine comprises an auxiliary slide which is displaceable relative to the workpiece support and relative to the base element parallel to the workpiece spindle axis. At least one auxiliary arm is connected to the auxiliary slide and to the meshing device, such that a displacement of the auxiliary slide relative to the base element effects a change in the radial spacing of the probe holder from the workpiece spindle axis. The auxiliary arm is preferably attached articulatedly between the auxiliary slide and the probe holder so as to form an auxiliary rocker.

In order to be able to easily axially displace the auxiliary slide, a second pull rod may be connected to the auxiliary slide, which second pull rod extends parallel to the workpiece spindle axis in order to displace the auxiliary slide parallel to the workpiece spindle axis. In particular, both the base element, formed as a slide, and the auxiliary slide may be connected to parallel pull rods and displaced separately from one another by means of said pull rods in order to thereby adjust the position of the probe holder both with respect to the axial direction parallel to the workpiece spindle axis and with respect to the radial direction perpendicular to the workpiece spindle axis.

To permit a motor-powered displacement of the auxiliary slide, the machine may comprise a second adjustment drive, in particular an NC-controlled servo motor. A second threaded spindle may interact with the second adjustment drive, which second threaded spindle extends parallel to the workpiece spindle axis and is connected directly or indirectly to the auxiliary slide such that an actuation of the second adjustment drive effects a displacement of the auxiliary slide parallel to the workpiece spindle axis. In particular, it is thus possible for both the base element and the auxiliary slide to be displaced in the same way by means of associated adjustment drives and threaded spindles.

A yet further arrangement for pivoting the probe holder may be provided in the case of the parallelogram guide already mentioned. Here, between the base element and the probe holder, there is provided an adjustment spindle which is arranged diagonally with respect to the parallelogram guide and which comprises a counter nut interacting therewith. By virtue of the effective length of the adjustment spindle between base element and the probe holder being varied, the pivot position of the probe holder relative to the base element can be varied. In particular, the adjustment spindle may be arranged diagonally between the joint axes of the parallelogram guide. Such an arrangement is suitable in particular for a manual adjustment of the pivot position of the probe holder.

The workpiece support may be static relative to the machine bed. In advantageous embodiments, the workpiece support is however movable, in particular pivotable, preferably pivotable about a vertical workpiece support axis, relative to the machine bed between at least two positions, in order to move the workpiece spindle(s) between at least a working position and a loading position.

In one advantageous embodiment, the device comprises a static machine bed, and the workpiece support is pivotable relative to the machine bed about a preferably vertical workpiece support axis between at least two positions. The at least one workpiece spindle is then arranged on the pivotable workpiece support so as to be movable between a working position and a loading position. Here, the workpiece spindle axis runs parallel to and with a spacing from the workpiece support axis. The workpiece spindle axis thus performs a circular-arc-shaped movement as the workpiece support rotates about the workpiece support axis. The meshing device is then arranged on the workpiece support, preferably between the workpiece spindle axis and the workpiece support axis. In other words, the meshing device is preferably situated in a region close to the center of the workpiece support. This prevents the meshing device from colliding with a gripper of a workpiece loading device or with the grinding tool.

In highly productive embodiments, the machine may comprise two parallel workpiece spindles which are both arranged on the movable workpiece support. Each of these workpiece spindles is then designed for the chucking of a workpiece and can be driven in rotation about a workpiece spindle axis. In such embodiments, each workpiece spindle is assigned in each case one meshing device, wherein each of the meshing devices comprises a probe holder, with a meshing probe which operates in contactless fashion, and a base element, which is displaceable parallel to the workpiece spindle axis, and wherein the probe holder is connected to the base element such that the probe holder has a variable radial spacing to the workpiece spindle axis. In particular, for this purpose, it is again possible for at least two rockers to be provided which, together with the probe holder and the base element, form a parallelogram guide. The meshing devices are then preferably constructed and arranged mirror-symmetrically or axially symmetrically with respect to one another.

In such embodiments, the machine may comprise a common first adjustment drive in order to displace the base elements of the two meshing devices simultaneously parallel to the workpiece spindle axis. Alternatively or in addition, said machine may comprise a common second adjustment drive in order to simultaneously vary the radial spacing of the two probe holders from the workpiece spindle axis, that is to say for example to pivot the probe holders of the two meshing devices simultaneously relative to the respective base elements. It is however also possible for respective separate adjustment drives to be provided for each meshing device in order to in each case individually displace the base element of each meshing device parallel to the workpiece spindle axis and/or in each case individually radially adjust the probe holder of each meshing device, that is to say for example pivot same relative to the corresponding base element. If each of the two meshing devices is separately adjustable both axially and radially, this means that a total of four separate adjustment drives are provided.

If the workpiece spindle axis runs vertically in space, an arrangement of the adjustment drives on a counter stand above the meshing device is advantageous even if the meshing device is constructed in a different manner to that described above. The present invention thus also relates to a machine for machining workpieces with pre-machined teeth, comprising:
a workpiece support;
at least one workpiece spindle for the chucking of a workpiece, the workpiece spindle being arranged on the workpiece support and being adapted to be driven in rotation about a workpiece spindle axis running vertically in space;
a meshing device which comprises a probe holder with a meshing probe which operates in contactless fashion, wherein the probe holder has an axially and/or radially variable position relative to the workpiece spindle axis,
wherein the machine comprises at least one adjustment drive for axially and/or radially varying the position of the probe holder relative to the workpiece spindle axis, and
wherein the adjustment drive is arranged on a counter stand of the workpiece support above the meshing device.

As has already been stated above, the drive is thus arranged at a location at which it does not pose an obstruction either during the machining process or during the workpiece change. Furthermore, sufficient space is available on the counter stand for the one or more relatively large drives.

In particular, at least one first adjustment drive and one second adjustment drive may be arranged on the counter stand, wherein the first adjustment drive effects a change in position of the probe holder at least axially relative to the workpiece spindle axis, and wherein the second adjustment drive effects a change in position of the probe holder at least radially relative to the workpiece spindle axis.

In one refinement, the machine again comprises a static machine bed, and the workpiece support is pivotable relative to the machine bed about a preferably vertical workpiece support axis between at least two positions. The at least one workpiece spindle is then arranged on the pivotable workpiece support so as to be movable between a working position and a loading position. Here, the workpiece spindle axis runs parallel to and with a spacing from the workpiece support axis. The meshing device is then arranged on the workpiece support preferably between the workpiece spindle axis and the workpiece support axis, as has already been described above.

In highly productive embodiments, the machine may again comprise two parallel workpiece spindles, which are both arranged on the movable workpiece support. Each of these workpiece spindles is then designed for the chucking of a workpiece and can be driven in rotation about a workpiece spindle axis running vertically in space. In such embodiments, each workpiece spindle is assigned in each case one meshing device, wherein each of the meshing devices comprises a probe holder with a meshing probe which operates in contactless fashion, and each of the probe holders has an axially and/or radially variable position relative to the workpiece spindle axis. The at least one adjustment drive is then designed to axially and/or radially vary the position of a probe holder relative to the workpiece spindle axis. The meshing devices are then in turn preferably constructed and arranged mirror-symmetrically or axially symmetrically with respect to one another.

The machine may again comprise a common first adjustment drive in order to simultaneously at least axially vary the position of the probe holders. Alternatively or in addition, said machine may comprise a common second adjustment drive in order to simultaneously at least radially vary the position of the probe holders. It is however also possible for in each case separate adjustment drives to be provided for each meshing device for this purpose.

All further considerations relating to a machine whose meshing device comprises an axially displaceable base element likewise apply analogously to embodiments in which the meshing device is of some other construction. Accordingly, the machine may comprise a first pull rod which is connected to the meshing device and which extends parallel to the workpiece spindle axis. By means of the first pull rod, it is possible for the position of the probe holder relative to the workpiece support to be adjusted at least axially (parallel to the workpiece spindle axis, that is to say in this case vertically). For the guidance of the meshing device, the machine may again comprise rollers which are arranged to both sides of the first pull rod and between which the first pull rod is longitudinally guided. In this case, the first pull rod and the rollers may together form a linear guide for the meshing device, or form a part of said linear guide. As already mentioned, the adjustment may take place in motor-driven fashion, in particular by means of an NC axis. For this purpose, the machine may comprise a first adjustment drive, in particular an NC-controlled servo motor. Furthermore, the machine may comprise a threaded spindle which interacts with the first adjustment drive and which extends parallel to the workpiece spindle axis and which is connected directly or indirectly to the meshing device such that an actuation of the first adjustment drive effects at least an axial change in position of the probe holder parallel to the workpiece spindle axis. The further presented considerations for the design of the adjustment mechanism apply here analogously. Also, all of the above considerations for the radial adjustment of the position of the probe holder apply analogously.

### BRIEF DESCRIPTION OF THE DRAWINGS

Preferred embodiments of the invention will be described below on the basis of the drawings, which serve merely for explanatory purposes and which are not to be interpreted as limiting. In the drawings:

FIG. 1 shows a schematic plan view of a gear cutting machine of the prior art according to WO 00/35621 A1;

FIG. 2 shows an isometric view of a gear cutting machine as per a first embodiment of the present invention;

FIG. 3 shows an isometric view of the workpiece support of the gear cutting machine as per FIG. 2;

FIG. 4 shows an enlarged detail view A of FIG. 3, which in particular more clearly shows the meshing device;

FIG. 5 shows an isometric view of the meshing devices and of the associated adjustment mechanisms in the case of the workpiece support as per FIG. 3;

FIG. 6 shows an enlarged detail view of the detail B in FIG. 5;

FIG. 7 shows a front view of the parallel kinematic arrangement of the meshing device as per FIG. 3 at the greatest workpiece diameter T;

FIG. 8 shows a front view of the parallel kinematic arrangement at the smallest workpiece diameter S;

FIG. 9 shows an isometric view of drive components for the meshing device in the case of the workpiece support as per FIG. 2;

FIG. 10 shows a plan view of the drive components as per FIG. 9, without servo drives;

FIG. 11 shows an isometric sectional view of the workpiece support as per FIG. 3;

FIG. 12 shows a front view of the meshing devices and of the associated adjustment mechanisms in the case of the workpiece support as per FIG. 3, partially in a sectional illustration;

FIG. 13 shows an isometric partial view of a gear cutting machine as per a second embodiment;

FIG. 14 shows an exploded view of the meshing device as per FIG. 13;

FIG. 15 shows an isometric partial view of a gear cutting machine as per a third embodiment without tailstock and workpiece;

FIG. 16 shows an isometric partial view of a gear cutting machine as per a fourth embodiment; and

FIG. 17 shows an isometric partial view of a gear cutting machine as per a fifth embodiment.

### DESCRIPTION OF PREFERRED EMBODIMENTS

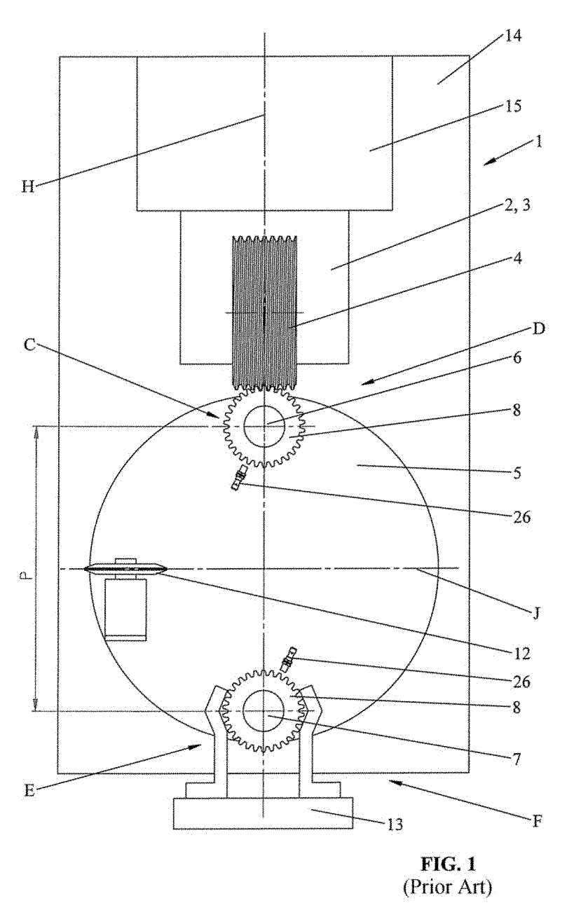

FIG. 1 shows a schematic plan view of a gear grinding machine 1 of the prior art according to WO 00/35621 A1, which serves for the machining of workpieces 8 with pre-machined teeth. Two vertical workpiece spindles 6, 7, which each define a workpiece spindle axis, and a pivotable dressing unit 12 are arranged on a pivotable workpiece support 5 in the form of a rotary table. The workpiece spindles have a spacing P to one another. The workpiece support 5 is pivotable about a central vertical workpiece support axis. It is arranged on a machine bed 14, which also bears a displaceable tool support 15. On the tool support 15, there is arranged a vertically advanceable Z slide, which in turn bears a pivotable grinding head 3. On the grinding head 2 there is arranged a longitudinally displaceable grinding slide 2 with grinding worm 4. The working chamber D is closed off in oil-tight fashion by means of a sealed hood (not illustrated) and the machine bed 14. The grinding oil is recirculated via said machine bed 14 into a coolant system (not illustrated). If, after the machining of a gear 8, the first workpiece spindle 6 is pivoted into the parking position E, then said gear 8 passes out of the contaminated and oily working chamber D into the relatively clean handling chamber F. In this parking position E, the automated workpiece change can then be performed by means of a gripper 13 of a workpiece feed device. During manual operation, this is performed by an operator. The interface between said working chamber D and the handling chamber F lies in the region of the central plane J illustrated in FIG. 1.

For the meshing, two meshing probes 26 are arranged on the pivotable workpiece support 5. Said meshing probes are arranged closely to the outer contour of the workpiece toothing to be measured, such that no collision with the grinding worm 4 or with the gripper 13 can occur. Thus, the known feed and return movement of the meshing probes from the measurement position at the workpiece into a collision-free parking position at the machine bed upon every workpiece change is eliminated. An automatic adjustment of the probe position is not provided, and is also not easy to realize owing to the restricted space conditions. The operator must therefore always manually position both meshing probes 26 during a batch change.

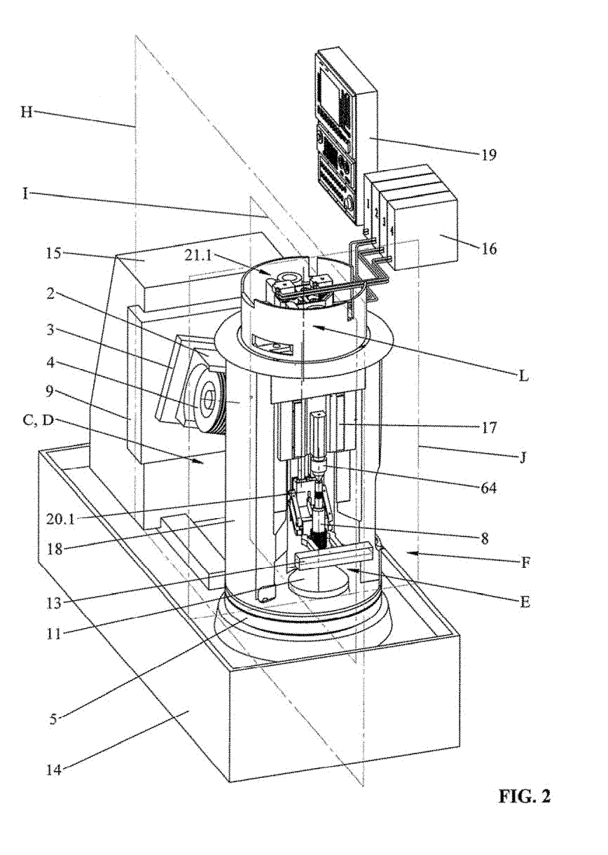

A first exemplary embodiment of a machine according to the invention for machining workpieces with pre-machined teeth is illustrated in FIGS. 2 to 12. Components of identical or similar action are denoted by the same reference designations as in FIG. 1.

Said machine also comprises a machine bed 14, on which there is arranged a pivotable workpiece support 5 in the form of a rotary table or rotary tower. The workpiece support 5 is pivotable about a vertical workpiece support axis L. Opposite the workpiece support 5, there is in turn situated a tool support 15 which is advanceable radially relative to the workpiece support axis L. Said tool support bears a vertically displaceable Z slide 9, on which there is arranged a pivotable grinding head 3. The grinding head 3 in turn bears a grinding slide 2 with a grinding spindle which drives a grinding worm 4 in rotation. The grinding slide 2 is arranged on the grinding had 3 so as to be longitudinally displaceable along the grinding spindle axis (shift axis). The workpiece support axis L and the advancing direction of the tool support 15 together define a central plane H of the machine as a whole.

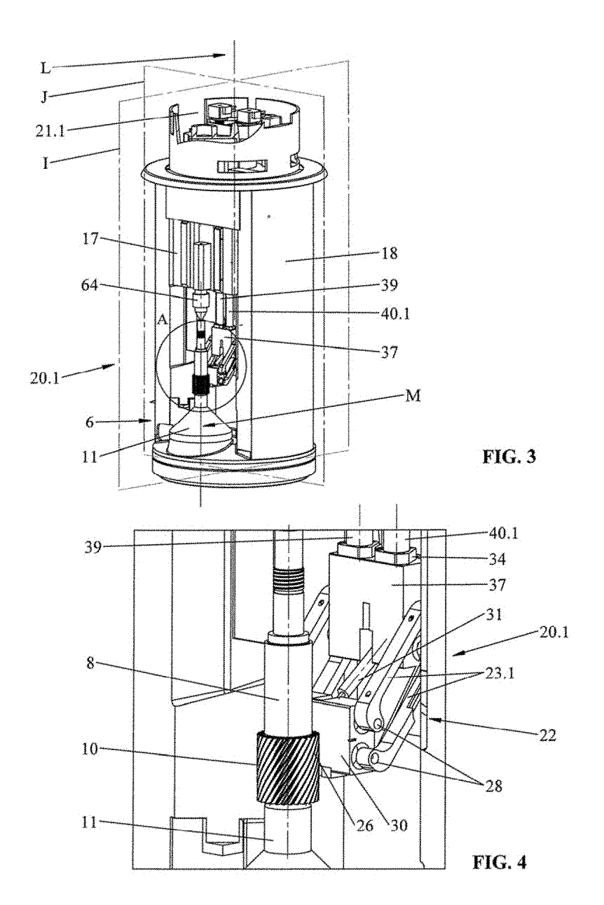

On the workpiece support 5, there are arranged two workpiece spindles 6, 7, which are situated diametrically oppositely in relation to the workpiece support axis L. Each of the workpiece spindles 6, 7 defines a workpiece spindle axis M (FIG. 3). The workpiece spindles 6, 7 are in each case pivotable between a working position C and a parking position E. In the working position C, the respective workpiece spindle is situated in a working chamber D. In the parking position E, the respective workpiece spindle is situated in a handling chamber F. In this parking position E, the automated workpiece change is performed by means of a merely schematically illustrated gripper 13 of a workpiece feed device.

The workpiece spindle axes M together define a first vertical central plane I of the workpiece support. A second vertical central plane J, which comprises the workpiece support axis L, of the workpiece support runs perpendicular to said first vertical central plane. During a pivoting movement of the workpiece support, the central planes I, J of the workpiece support change their orientation relative to the central plane H of the machine.

The workpiece support 5 comprises a counter stand 18 which extends upward between the workpiece spindles 6, 7 and which bears the tailstocks 17 for the two workpiece spindles. During operation, workpieces 8 with pre-machined teeth are held by workpiece chucking means 11 on the workpiece spindles 6, 7, and are optionally also additionally held by means of centering tips 64 on the tailstocks 17. Between the workpiece spindle axes, close to the second central plane J, there are situated two identical meshing devices 20.1 which are arranged symmetrically with respect to the workpiece support axis. Said meshing devices are displaceable in a synchronous manner vertically with respect to the workplace support 5 and the counter stand 18. The meshing devices 20.1 comprise in each case one meshing probe. The meshing probes can be synchronously pivoted inward radially toward the workpiece spindle axes M in the first central plane I, as will be described in more detail below.

In order to synchronously vertically displace the meshing devices and synchronously pivot the meshing probes inward, the machine comprises a central drive unit 21.1. Said drive unit is arranged fixedly on the top side of the counter stand 18. The drive unit 21.1 is actuated by a CNC controller 16. The CNC controller may be operated by means of an operator control panel 19. It is thus possible for the positions of the two meshing probes to be automatically varied synchronously even during the grinding process. This feature opens up the possibility of grinding block toothings, wherein both toothings must be manufactured with accurate angular positioning relative to one another.

The construction of the meshing devices 20.1 emerges in particular from FIGS. 3-6.

Each meshing device comprises a base element 37, which is formed as a vertically displaceable slide, and a probe holder 30, which bears an easily exchangeable meshing probe 26. The base element 37 and probe holder 30 are articulatedly connected by means of multiple rockers 23.1. In each case two of these rockers 23.1, which are arranged on the same side of the base element and of the probe holder, form, together with the base element and the probe holder, a double rocker drive 22. The two double rocker drives define a parallelogram guide, that is to say the parallel joint axes O1-O4 (FIG. 6) about which the rockers are articulatedly connected to the base element and to the probe holder form, in a projection into a plane perpendicular to said joint axes (that is to say into the central plane I), the corner points of a parallelogram. In this way, the probe holder 30 is pivotable relative to the base element 37 in the central plane I along a curved path in the direction of the workpiece toothing 10. Here, the probe holder 30 is held exactly parallel to the vertically displaceable base element 37 by means of the two double rocker drives 22.

Play-free, rigid, preloaded rotary joints 28 mounted by means of rolling bearings and having seals are arranged in the joint axes O1-O4 of the rockers 23.1. The base element 37 takes up no space in the critical space behind the workpiece toothing 10, because, in all vertical positions, said base element is always situated above the workpiece toothing 10. The rockers 23.1 are identical parts, are of equal length, and are arranged in a thermally symmetrical manner. Thermal effects resulting from the fast-rotating grinding worm 4 thus cannot give rise to oblique positioning of the probe 26.

As meshing probes 26, use may be made of inductive or capacitive sensors known from the prior art. These sensors, which operate in contactless fashion, do not give rise to a measuring force during the meshing process. Often, meshing probes with small diameter are required for small module sizes, and meshing probes of relatively large diameter are required for relatively large module sizes. Therefore, the meshing probe 26 are received in the probe holder 30 by means of an adapter part 24, which is arranged displaceably relative to the probe holder 30. During the sensor change in the course of the setup process, the fine adjustment of the end surface 27 of the respective meshing probe 26 can be performed by means of said adapter part 24.

In order to linearly guide the base element 37, formed as a slide, along the vertical, the machine comprises a linear guide for each meshing device. Said linear guide is formed by two cylindrical guide tubes 39, 40.1 and, interacting therewith, rigidly but rotatably received rollers 29.1 and elastically and rotatably received rollers 29.2. Each roller has a running surface which is concavely curved in longitudinal section. Each of the cylindrical guide tubes 39, 40.1 is guided between two pairs, arranged one above the other, of rollers 29.1, 29.2 in the manner of a cylindrical round guide. The rollers 29.1 and 29.2 are, for this purpose, mounted on the counter stand such that, during the retraction of the tubes 39, 40.1, a resilient bias force arises between the rollers of each pair. As a result, each of the guide tubes 39, 40.1, together with in each case two pairs, arranged one above the other, of rollers 29.1, 29.2, forms a play-free, preloaded linear guide. The linear guides are designed as identical parts. They can be produced very inexpensively. The tubes 39, 40.1 are connected, so as to be adjustable by means of clamping pieces 34, to the base element 37 of the respective meshing device. As discussed in more detail below, the respective guide tube 39 forms a pull rod, by means of which the corresponding meshing device can be vertically adjusted.

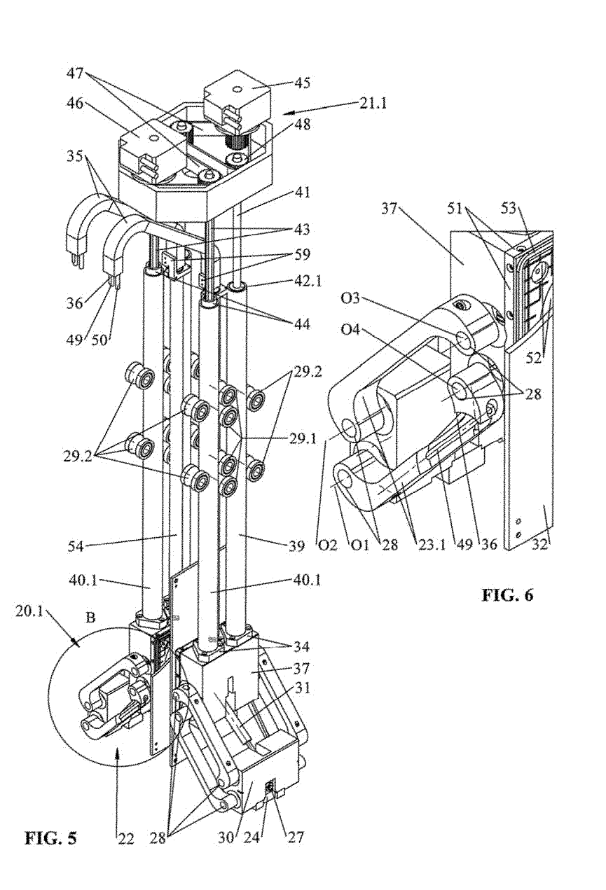

Each base element 37 bears not only the two guide tubes 39 and 40.1 which serve for the guidance but also a protective tube 54 which, at the upper end, is connected by means of a clamping piece 59 to a power chain 35 (see FIG. 5). The latter accommodates an electrical cable to the probe 36 and two feed lines 49 and 50 for the supply of air. The protective tube 54 is designed such that, if required, yet further lines for other sensors, such as for example ultrasound, laser or temperature, can be accommodated. By means of a temperature sensor, it is for example possible to determine a corrective value relating to the length expansion of the relatively long linear guides 39 and 40, using which the CNC controller 16 then eliminates these disturbance values. The electrical cable 36 is guided out of the lower end of the protective tube 54 via the base element 37 and via a rocker 23.1 to the probe 26. Furthermore, compressed air for the cleaning of the probe 26 is supplied via a feed line 49 and via bores in the slide 37, rotary joint 28, rocker 23.1 and the probe holder 30 (see FIG. 6).

In the base element 37, a compressed-air branch line leads to the rear side of the base element. The rear side is provided with a sliding plastics layer (see FIG. 6), preferably composed of an SKC™ slide lining, in which an encircling groove and multiple cutouts 53 are formed. The groove and cutouts 53 are connected by means of a grid approximately 1 mm deep. A further circular cutout 52 is arranged in the center of said plastics layer and a supply is provided thereto via a second bore in the slide 37 with a feed line 50. The acting cutouts 52 and 53 are not connected to one another. If, in the set vertical measurement position G, the feed line 50 is now supplied with negative pressure, then the slide 37 is firmly attached by suction to a plate 32 on the counter stand 18 and is fixed to said plate. If the slide 37 is then to be moved again, then the air supply at the feed line 50 is switched to compressed air, and, together with the already activated compressed air from feed line 49 and the strippers 51, the plate 32 is cleaned. The cleaning effect is better in the case of an antimagnetic plate 32 being used, because the electrostatically charged grinding chips then cannot adhere. Upon the renewed fixing, the air supply 50 is switched to negative pressure again, and the displaceable base element 37 is firmly attached by suction again.

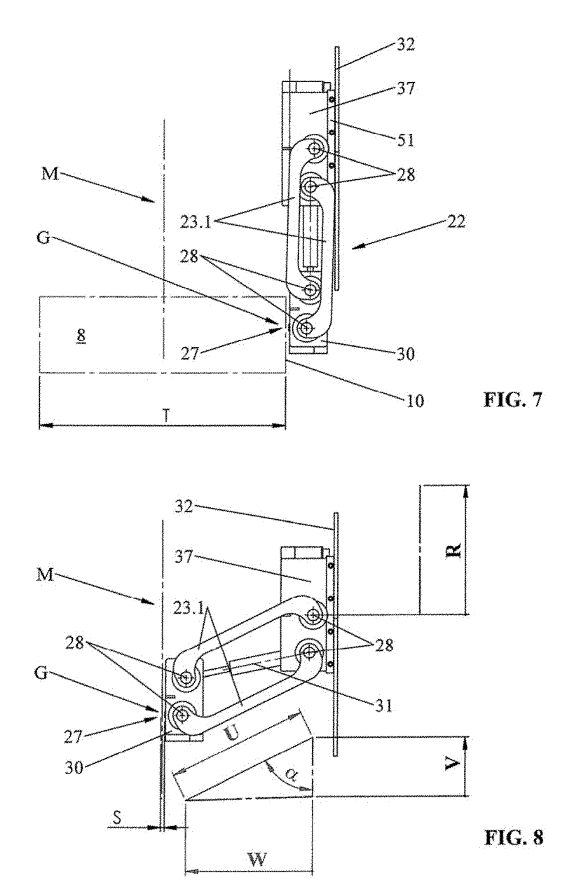

FIGS. 7 and 8 illustrate the double rocker drive 22 for the largest gear 8 (diameter T) and the smallest gear (diameter S). The pivot angle α lies generally between 0° and 90°. The maximum vertical displacement travel of the base element is denoted by R. The radial advancing stroke W generated as a result of a pivoting of the probe holder 30 always also gives rise to a vertical additional stroke V. In the case of a rocker length U, the following thus applies:

0°<α<90° (1)

W=U*sin α (2)

V=U*cos α (3)

W=V*tan α (4)

This vertical additional stroke V must thus be added to the vertical stroke R during the vertical positioning of the probe holder 30. The two Figures also show that the base element 37 is always arranged above the workpiece toothing 10 and thus does not take up any structural space behind it.

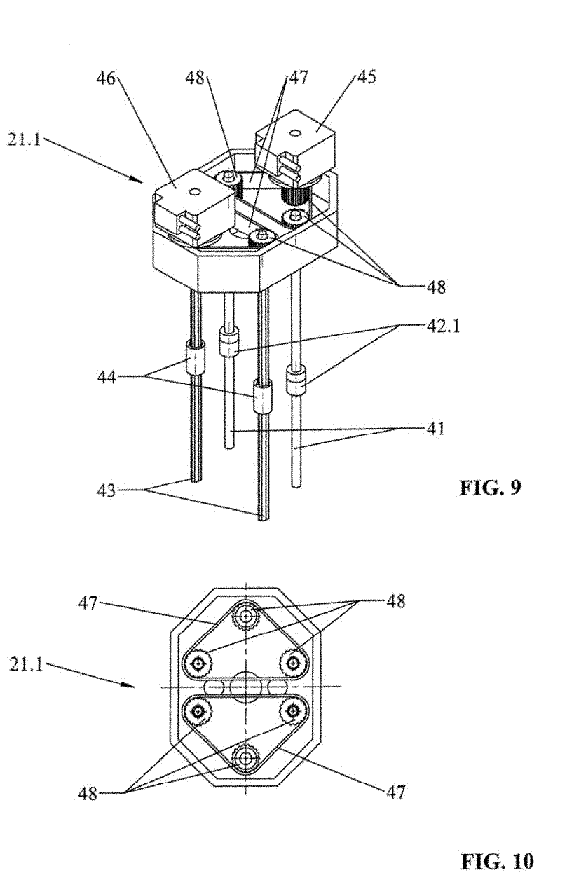

FIG. 5 shows a drive unit 21.1. Said drive unit serves for the motor adjustment of the position of the two meshing devices 20.1 along the vertical and the pivot angles of the double rocker drives 22. FIGS. 9 and 10 illustrate the drive unit 21.1 in further views. The drive unit 21.1 comprises a first servo drive 45 and a second servo drive 46. The rotational movement generated by the first servo drive 45 is transmitted by means of a tensioned toothed belt 47 to two identical threaded spindles 41. For this purpose, the pinions 48 on which the toothed belt 47 runs are arranged in the corners of an isosceles triangle. The rotational movement, which is generated by the second servo drive 46, is, by contrast, transmitted by means of a tensioned toothed belt 47 to two identical spline shafts 43. It is also the case in the second servo drive 46 that the pinions 48 on which the toothed belt 47 runs are arranged in the corners of an isosceles triangle. Both servo drives 45, 46 are arranged in displaceable fashion and can be displaced for the purposes of setting the belt preload.

On each of the threaded spindles 41 there runs in each case one nut 42.1 of a play-free, preloaded ball screw drive. Said nut is attached rigidly to the upper end of the respective guide tube 39, which in turn is connected rigidly to the base element of one of the meshing devices. The threaded spindle 41 thus extends partially into the guide tube 39. A rotation of the axially positionally fixedly arranged threaded spindle 41 causes a change of the position of the rotationally fixedly arranged nut 42.1 along the vertical. The nut 42.1 correspondingly drives the guide tube 39 and thus the base element 37 of the respective meshing device along with it. Thus, the guide tube 39 acts as a pull rod for the vertical adjustment of the position of the meshing device. By means of the toothed belt drive, the adjustment of the two meshing devices takes place synchronously by means of the first servo drive 45.

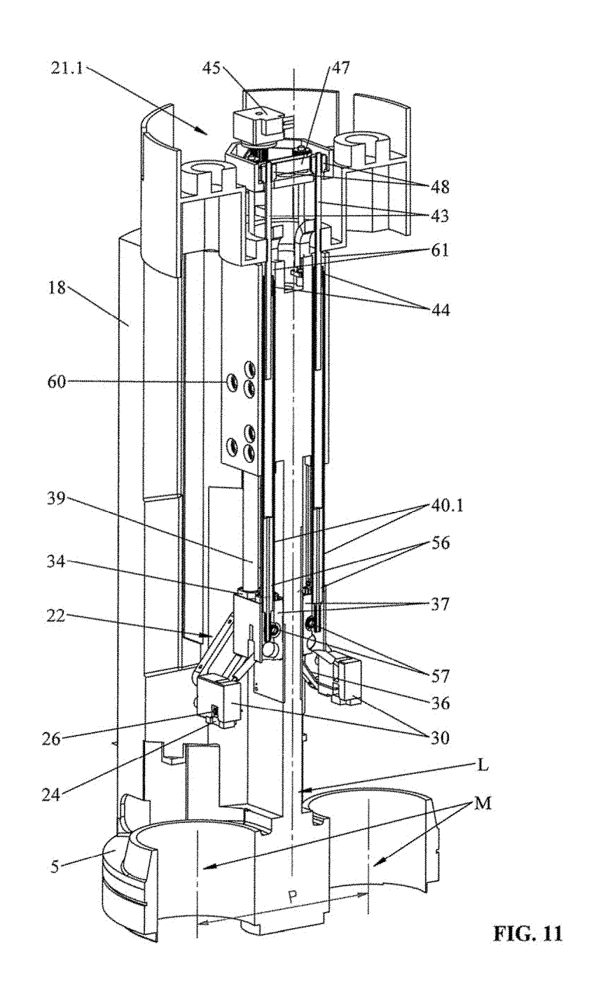

The radial positioning of the two probe holders 30 takes place analogously synchronously by means of the servo drive 46. This is additionally illustrated in FIG. 11. Each of the spline shafts 43 interacts with a play-free, preloaded spline hub 44 of a ball spline shaft drive. Said spline hub 44 is held axially fixedly but rotatably in the upper end of the guide tube 40.1. Said spline hub is rigidly connected to the upper end of a drive shaft 56, which is guided rotatably in the guide tube 40.1 (see FIG. 11). At its lower end, the drive shaft 56 is equipped with a worm which drives an output wheel 57. The output wheel 57 is seated on one of the joint axes of the parallelogram guide and is rigidly connected to one of the rockers 23.1 of the double rocker drive 22. A rotation of the drive shaft 56 thus causes a pivoting movement of the rockers 23.1. The pivoting of the probe holders 30 of the two meshing devices inward is thus performed synchronously by means of the second servo drive 46.

In this way, the meshing probe 26 of each of the two meshing devices can be positioned by means of the two servo drives 45, 46 such that the spacing of the end surface 27 of the meshing probe 26 to the workpiece toothing 10 amounts to approximately 0.5 to 1 mm. For this purpose, the operator can, on the operator control panel 19, input the respective radial and vertical position for the probes 26. The automatic approach to the toothing 10 is then performed by means of the two servo drives 45, 46 and the CNC controller 16 that is provided. Both probes 26 are activatable in accordance with demand.

It is alternatively possible for in each case one separate servo drive to be provided for each threaded spindle and for each spline shaft, such that each meshing probe can be separately adjusted. For this purpose, four servo motors with controllers are required, with correspondingly higher costs.

The ball screw drives 41, 42.1 and ball spline shaft drives 43, 44, which are in each case used in duplicate, are arranged symmetrically with respect to the central plane I and are composed of identical parts. In this way, adverse thermal influences are reduced.

The drive train for the pivoting of the double rocker drive 22 has a degree of play. To eliminate this play, a gas spring 31 is provided which is arranged diagonally between the joint axes of the parallelogram guide and which generates a counter-load. The stroke of the gas spring 31 increases with radial advancement of the probe holder 30 in the direction of the workpiece toothing. Said gas spring thus ensures that the abutting worm flank of the drive shaft 56 is always loaded by the weight of the probe holder 30 and additionally by said counter-load. In this way, an undesired flank change on the worm, that is to say play in the tooth flank, is avoided. The permanently acting force in the gas spring 31 furthermore prevents a disturbing vibration of the probe holder 30.

The drive unit 21.1 is arranged on the counter stand 18 at the upper end thereof. In this upper arrangement, the drive unit 21.1 can be of relatively large construction. Owing to the upper arrangement, collisions with a gripper 13 of a loading device, the handling chamber F of which is always situated in the lower region of a workpiece 8 at the parking position E, are avoided. The probe holder 30 is, by contrast, arranged directly behind the workpiece toothing 10. Said probe holder is situated in a region close to the center between workpiece support axis and workpiece spindle axis, which region is protected against collisions with the gripper 13. In this measurement position G, the probe holder 30 does not imperatively have to be removed, as was hitherto conventional, during the workpiece change, but rather may remain in the selected position G. The respective probe central axis N is arranged in the central plane I of the pivotable workpiece support 5.

In FIG. 11, horizontal and vertical bores 60, 61 can be seen in the upper, protected part of the counter stand 18. The horizontal bores 60 serve for the mounting of the rollers 29.1 and 29.2. They have tolerances such that, during the retraction of the guide tubes 39 or 40.1, a resilient preload force arises as a result of the two rollers 29.2 being received in elastic fashion. The vertical bores 61 serve for the leadthrough of the guide tubes 39, 40.1 through the counter stand. The cylindrical guide tubes 39 and 40.1 can be protected from grinding oil, grinding sludge and grinding wheel abrasion by means of simple seals.

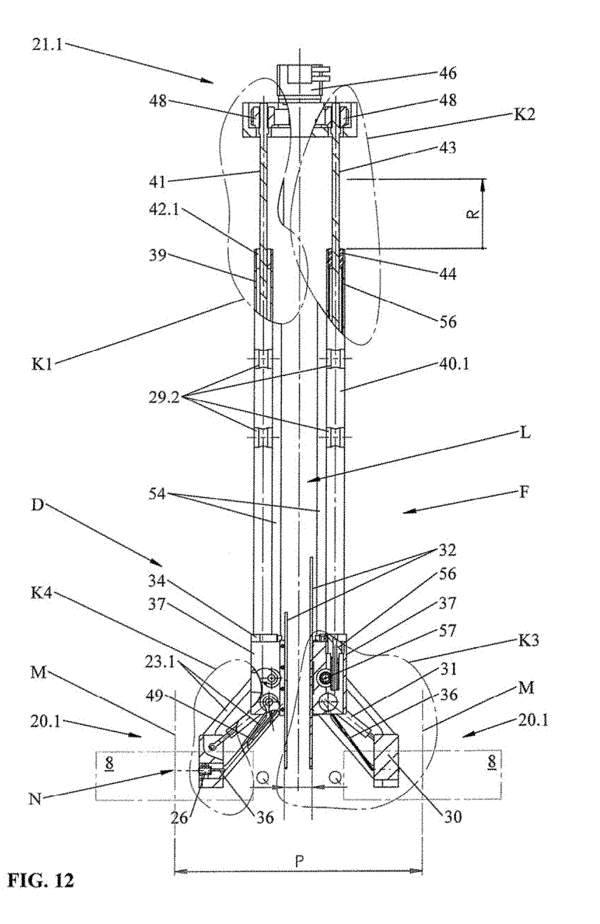

FIG. 12 once again shows details of the drivetrains for the vertical displacement of the meshing devices and for the pivoting movement of the probe holders. For this purpose, in FIG. 12, four cutaway views K1 to K4 with different depths are illustrated. In the upper left cutaway view K1, the spindle 41 of the ball screw drive for the left-hand meshing device with the associated nut 42.1 and the associated guide tube 39 can be seen. The right-hand cutaway view K2 situated adjacent thereto shows the ball spline shaft 43 for the right-hand meshing device with spline hub 44 and the guide tube 40.1, in which the rotatable drive shaft 56 is accommodated. In the lower right cutaway view K3, said drive shaft 56 is illustrated with worm and output wheel 57. The lower left cutaway view K4 shows the probe 26 arranged in the central plane I with its electrical cable 36 and its probe longitudinal axis N, the pivotable gas spring 31, and the feed line 49 for the compressed air.

The above-discussed meshing device of the first embodiment is, in the contaminated working chamber D, relatively insensitive to coolant, grinding sludge and grinding wheel abrasion, because the guide tubes 39 and 40.1 are accommodated in the upper, protected part of the counter stand 18, and the slide 37 situated in the working chamber D can be adequately protected by means of stripper 51, sealing air 49 and an antimagnetic plate 32. The rotary joints 28—likewise in the working chamber D—can be sealed off in uncritical fashion by means of seals. By contrast, the entire drive unit 21.1 is arranged in the upper, protected part of the counter stand 18, outside the working chamber D, and is reliably protected against contamination.

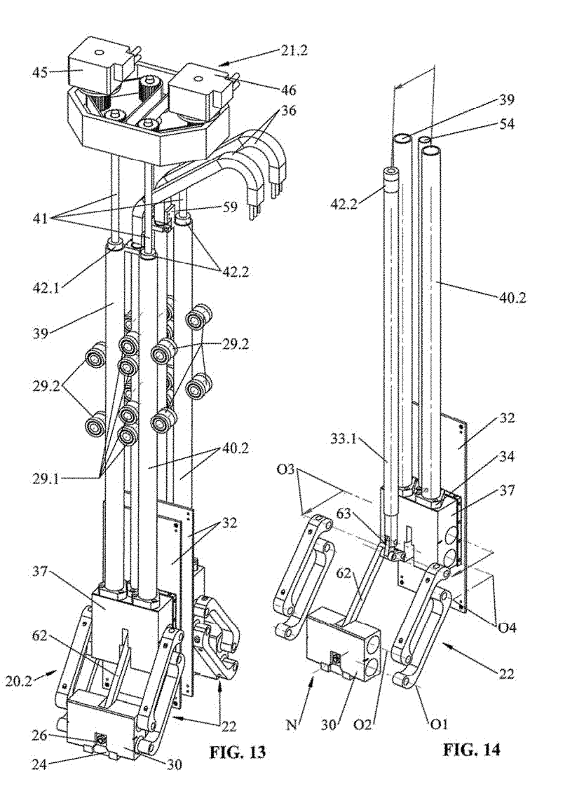

FIGS. 13 and 14 illustrate a second embodiment of a gear-machining machine with a meshing device 20.2. Parts of identical or similar function are denoted by the same reference designations as in the first embodiment, and will not be described again. This embodiment differs from the first embodiment in particular by the manner in which the probe holder 30 is pivoted relative to the base element 37. For this purpose, a play-free lever structure is installed instead of the play-afflicted angle drive composed of drive shaft 56 and output wheel 57. The ball spline shaft 43 with spline hub 44, the drive shaft 56 and the output wheel 57 of the first embodiment are replaced by a further ball screw drive composed of threaded spindle 41 and nut 42.2, a pull rod 33.1, an intermediate piece (compensating element) 63 and a knee-lever-like pivot lever 62. The two pivot axes of said pivot lever 62 are arranged in each case concentrically with respect to the joint axis O2 in the probe holder 30 and with respect to the joint axis O3 in the base element 37. The compensating element is arranged pivotably between the pull rod 33.1 and an engagement point, arranged between the joint axes O2 and O3, on the pivot lever 62. The exploded illustration in FIG. 14 shows the arrangement of these parts in the probe holder 30 and in the base element 37.

The rotating servo drive 46 and the ball screw drive with threaded spindle 41 are fixedly connected by means of the play-free nut 42.2 to the pull rod 33.1. Said pull rod performs a vertical stroke movement. Said pull rod 33.1 is installed into a cylindrical guide tube 40.2 and is connected in play-free fashion by means of the intermediate piece 63 to an engagement point of the pivot lever 62. During a stroke of the pull rod 33.1, the coupled-on probe holder 30 performs a corresponding pivoting movement. If the pull rod 33.1 is displaced upward, then the probe holder 30 is pivoted inward in the direction of the axis of rotation M of the workpiece spindle. If the pull rod 33.1 is displaced downward, then the probe holder 30 is pivoted away from the axis of rotation M of the workpiece spindle. Pivot lever 62 and rocker 23.1 are of equal length. The pivot lever 62 is furthermore arranged centrally in said meshing device 20.2. The modified drive unit 21.2 is of analogous construction to the drive unit 21.1. The radial and vertical positioning of the probe 26 is in this case also input at the operator control panel 24, and can be approached automatically.

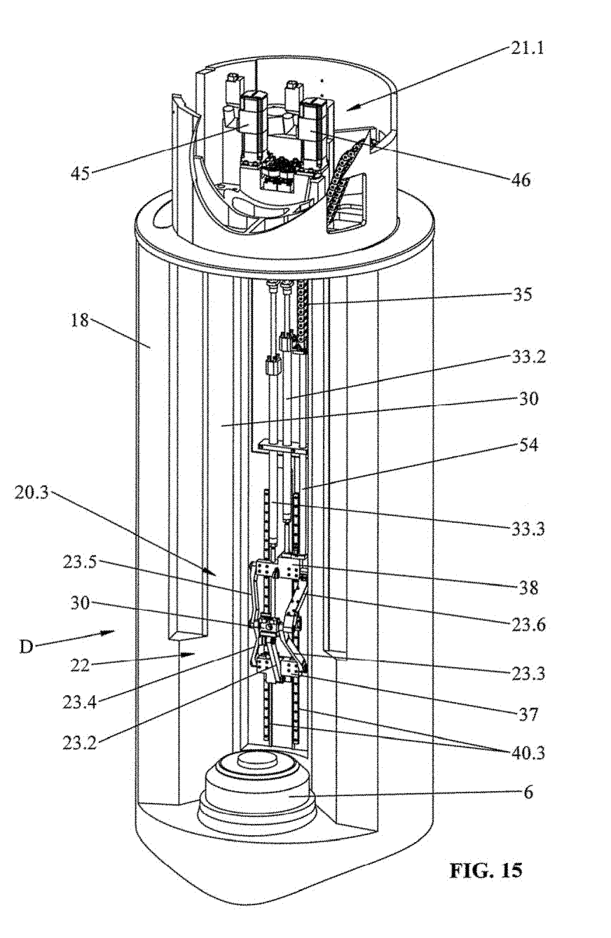

FIG. 15 shows a third embodiment of a gear-machining machine with meshing device 20.3. Again, parts of similar function are denoted by the same reference designations as in the first embodiment. The machine of FIG. 15 comprises not only the parallelogram guide with base element 37 and probe holder 30 but also an auxiliary slide 38 which is connected to the probe holder 30 by means of two auxiliary rockers 23.5, 23.6. The base element 37 can be displaced by the first servo drive 45 via a cylindrical pull rod 33.3. The auxiliary slide 38 can be displaced by the second servo drive 46 via a cylindrical pull rod 33.2. The parallelogram guide provided for maintaining the vertical position of the probe holder 30 and for the radial advancement thereof has in this case only three rockers, specifically a central rocker 23.2 and in each case one rocker 23.3 and 23.4 to both sides. The auxiliary rockers 23.5 and 23.6 are arranged to both sides of the probe holder 30. All of the rockers 23.2 to 23.6 are of equal length. The vertical guidance of the base element 37 and of the auxiliary slide 38 is realized by means of two separate play-free guides on guide rails 40.3, which are situated in the working chamber D and are thus sealed off.

The radial and vertical position of the probe 26 is in this case likewise input at the operator control panel 24. Firstly, with a displacement of the base element 37 and the auxiliary slide 38 in opposite directions, the radial advancing stroke W is set, and subsequently, the base element 37 and the auxiliary slide 38 are displaced synchronously to the vertical position.

This embodiment 20.3 offers advantages in particular if the cylindrical linear guides of the first embodiment cannot be accommodated in the upper part of the counter stand 18 for space reasons.

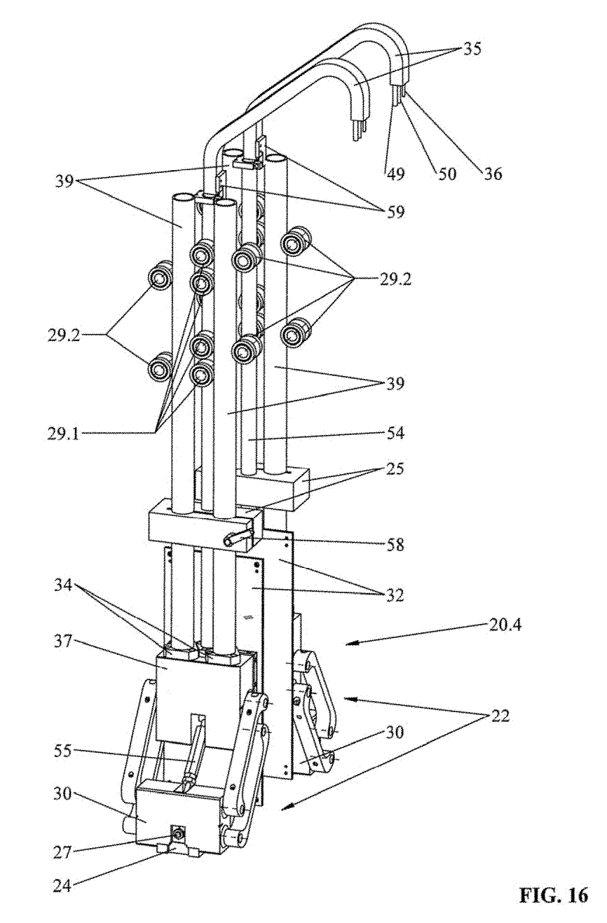

FIG. 16 illustrates a fourth embodiment, which can be regarded as a modification of the first embodiment. Again, parts of similar function are denoted by the same reference designations as in the first embodiment. In this embodiment, the adjustment of the meshing device 20.4 is performed purely manually. The base element 37 is displaced by hand for the axial adjustment of the height. For the fixing, the guide tubes 39 are fixed to a clamping strip 25 by means of a clamping lever 58. The radial adjustment takes place separately by means of an adjustment spindle 55 with counter nut, which is arranged diagonally centrally with respect to the parallelogram guide, analogously to the gas spring 31 of the first embodiment.

This manually adjustable device 20.4 can be advantageously used if no automated mass production is necessary and the time for the manual operation is uncritical. The costs can, for this purpose, be significantly reduced as a result of omission of the entire drive unit 21.1.

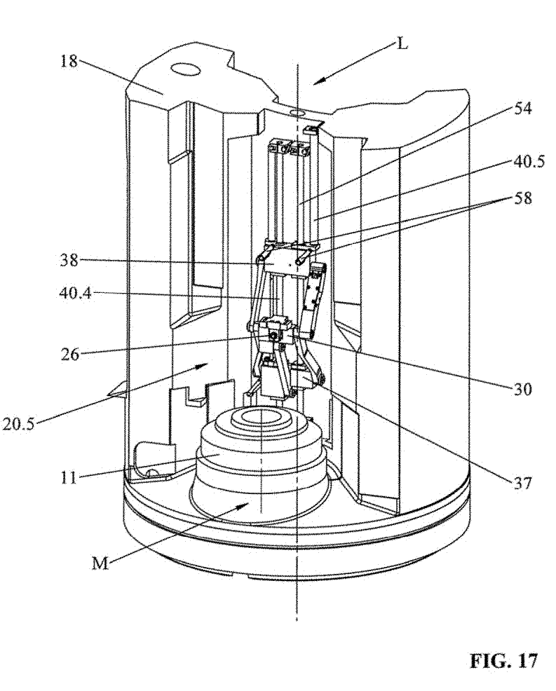

FIG. 17 illustrates a fifth embodiment which can be regarded as a modification of the third embodiment. Again, parts of similar function are denoted by the same reference designations as in the first embodiment. In this embodiment, too, the adjustment of the meshing device 20.5 is performed purely manually. Here, the adjustment of the base element 37 and of the auxiliary slide 38 is performed by hand. For the fixing of both positions, two clamping levers 58 are used. The vertical guidance of the two slides 37 and 38 is realized here by means of cylindrical linear guides with guide rods 40.4 and 40.5.

Whereas it is the case in the embodiments described above that in each case two workpiece spindles with associated meshing devices are provided, one of these workpiece spindles may also be omitted.

In all of the above-stated embodiments, the meshing is preferably performed in the parking position E and/or during the pivoting of the workpiece support 5, though it may also be performed in the working position C.

If servo drives are present for the adjustment of the vertical position of the base element and for the adjustment of the pivot position of the probe holder, the meshing device can, in the case of the machining of block gears, be automatically moved to multiple toothings of the block gear, in order to center these in each case.

The meshing devices of the embodiments discussed above are all very rigid, both in the pivoting direction and also radially and vertically. They can very effectively accommodate the high forces during the acceleration of the pivotable workpiece support 5, and exhibit very good dynamic characteristics. In the first embodiment, the dynamic characteristics are additionally improved through the installation of a damping gas spring 31 and by means of the fixed attachment of the base element 37 by suction to the counter stand 18 in any desired vertical position; disturbing vibrations are additionally avoided in this way.

By means of the parallelogram kinematic arrangement, the above-discussed meshing devices all perform positioning with very high repeat accuracy. As a result of a thermally symmetrical arrangement of the rockers of the parallelogram guide and the design thereof as identical parts, a high level of thermal stability is ensured. Oblique positioning as a result of thermal growth is thus practically ruled out.

The displaceable parts of the meshing devices discussed above are relatively lightweight and can be positioned using servo motors of relatively small construction, or by manual force. The probe holder 30 can be of very small and flat dimensions, and therefore requires little space in the critical structural space behind the workpiece toothing 10.

The meshing devices discussed above may comprise further sensors (for example laser, ultrasound, temperature) in addition to the meshing probes 26.

The meshing devices discussed above are all of modular construction and therefore very easy to maintain.

### LIST OF REFERENCE DESIGNATIONS

1 Gear grinding machine

2 Grinding slide

3 Grinding head

4 Grinding worm wheel

5 Workpiece support

6 Workpiece spindle

7 Workpiece spindle

8 Gear

9 Z slide

10 Workpiece toothing

11 Workpiece chucking means

12 Dressing unit

13 Workpiece gripper

14 Machine bed

15 Tool support

16 CNC controller

17 Tailstock

18 Counter stand

19 Operator control panel

20.1 . . . 20.6 Meshing device

21.1, 21.2 Drive unit

22 Double rocker drive

23.1 . . . 23.6 Rocker

24 Adapter part

25 Clamping strip

26 Probe for meshing

27 End surface of the probe

28 Rotary joint

29.1, 29.2 Roller

30 Probe holder

31 Gas spring

32 Plate, anti-magnetic

33.1 . . . 33.3 Pull rod

34 Clamping piece

35 Power chain

36 Electrical cable to the probe

37 Base element (slide)

38 Auxiliary slide

39 Guide tube

40.1, 40.2 Guide tube

40.3 Guide rail

40.4, 40.5 Guide rod

41 Spindle of a ball screw drive

42.1, 42.2 Nut of the ball screw drive

43 Ball spline shaft

44 Ball spline hub

45 Servo drive for vertical adjustment

46 Servo drive for radial pivoting

47 Toothed belt

48 Pinion for toothed belt drive

49 Feed line for compressed air

50 Feed line for suction or compressed air

51 Stripper

52 Cutout for attachment by suction and repulsion by pressure

53 Cutouts for sealing

54 Protective tube

55 Adjustment spindle with locknut

56 Drive shaft with pinion

57 Output wheel

58 Clamping lever

59 Clamping piece

60 Bore, horizontal

61 Bore, vertical

62 Pivot lever

63 Intermediate piece

64 Centering tip

A Detail view

B Detail view

C Working position

D Working chamber

E Loading or parking position

F Handling chamber

G Measurement position

H Central plane of the machine

I First central plane of the workpiece support

J Second central plane of the workpiece support

K1 . . . K4 Cutaway view

L Workpiece support axis

M Workpiece spindle axis

N Central axis of the meshing probe

O1 . . . O4 Joint axis

P Centre spacing between the two workpiece spindles

Q Minimum spacing between vertical slide and central plane J

R Displacement travel

S Workpiece diameter, min

T Workpiece diameter, max

U Length of the rocker

V Vertical additional stroke

W Radial advancing stroke

α Pivot angle

1. A machine for machining workpieces with pre-machined teeth, comprising:
a workpiece support;
at least one workpiece spindle for the chucking of a workpiece, the workpiece spindle being arranged on the workpiece support and being adapted to be driven in rotation about a workpiece spindle axis;
a meshing device, the meshing device comprising a base element and a probe holder with a meshing probe for contactless operation, the probe holder being connected to the base element such that the probe holder has a variable radial spacing to the workpiece spindle axis,
the base element being formed as a slide which is movable relative to the workpiece support; and
a linear guide for the base element so as to permit a displacement of the base element relative to the workpiece support parallel to the workpiece spindle axis.

2. The machine as claimed in claim 1, wherein the machine comprises a first adjustment drive, for displacing the base element parallel to the workpiece spindle axis, and/or a second adjustment drive, for effecting a change of the radial spacing of the probe holder to the workpiece spindle axis.

3. The machine as claimed in claim 2,
wherein the workpiece spindle axis runs vertically in space, and
wherein the first and/or second adjustment drives are arranged on a counter stand of the workpiece support above the meshing device.

4. The machine as claimed in claim 1, comprising:
a pull rod which is connected to the base element and which extends parallel to the workpiece spindle axis in order to displace the base element relative to the workpiece support parallel to the workpiece spindle axis.

5. The machine as claimed in claim 4, comprising:
rollers which are arranged to both sides of the pull rod and between which the pull rod is longitudinally guided such that the pull rod and the rollers together form at least one part of the linear guide for the base element.

6. The machine as claimed in claim 1,
comprising a guide plate which is arranged on the workpiece support and which defines a guide surface running parallel to the workpiece spindle axis,
wherein the base element has a complementary slide surface which is configured to slide in displaceable fashion on the guide surface of the guide plate in order to form an additional sliding guide for the base element, and
wherein, in the slide surface, there is provided a suction opening for fixing of the base element to the guide plate by means of negative pressure.

7. The machine as claimed in claim 1, comprising:
an adjustment drive; and
a threaded spindle which interacts with the adjustment drive and which extends parallel to the workpiece spindle axis and which is connected directly or indirectly to the base element such that an actuation of the adjustment drive effects a displacement of the base element parallel to the workpiece spindle axis.

8. The machine as claimed in claim 7,
comprising a tubular pull rod which is connected to the base element and which extends parallel to the workpiece spindle axis,
wherein the threaded spindle extends into the interior of the tubular pull rod, and
wherein the machine comprises a nut which is rigidly connected to the tubular pull rod and which interacts with the threaded spindle in order to effect, as a result of a rotation of the threaded spindle, a displacement of the tubular pull rod parallel to the workpiece spindle axis.

9. The machine as claimed in claim 1, comprising:
a drive shaft which extends parallel to the workpiece spindle axis and which is rotatable relative to the base element; and
a gearing which is arranged on the base element in order to convert a rotational movement of the drive shaft into a movement which effects a change of the radial spacing of the probe holder from the workpiece spindle axis.

10. The machine as claimed in claim 9, comprising a spring which generates a counter-load in the gearing for preventing flank changes in the gearing.

11. The machine as claimed in claim 9, comprising:
an adjustment drive;
a spline shaft which interacts with the adjustment drive and which extends parallel to the workpiece spindle axis; and
a spline hub which is connected to the drive shaft and which is in engagement in longitudinally displaceable and rotationally conjoint fashion with the spline shaft in order to transmit a rotational movement of the adjustment drive to the drive shaft.

12. The machine as claimed in claim 1, comprising:
a pull rod which extends parallel to the workpiece spindle axis and which is axially displaceable relative to the base element; and
a lever mechanism which connects the pull rod to the meshing device such that an axial displacement of the pull rod relative to the base element effects a change of the radial spacing of the probe holder from the workpiece spindle axis.

13. The machine as claimed in claim 1, comprising:
an auxiliary slide which is displaceable relative to the workpiece support and relative to the base element parallel to the workpiece spindle axis; and
at least one auxiliary arm which is connected to the auxiliary slide and to the meshing device such that a displacement of the auxiliary slide relative to the base element effects a change of the radial spacing of the probe holder from the workpiece spindle axis.

14. The machine as claimed in claim 13, comprising:
a pull rod which is connected to the auxiliary slide and which extends parallel to the workpiece spindle axis in order to displace the auxiliary slide parallel to the workpiece spindle axis.

15. The machine as claimed in claim 13, comprising:
an adjustment drive; and
a threaded spindle which interacts with the adjustment drive and which extends parallel to the workpiece spindle axis and which is connected directly or indirectly to the auxiliary slide such that an actuation of the adjustment drive effects a displacement of the auxiliary slide parallel to the workpiece spindle axis.

16. The machine as claimed in claim 1, wherein the meshing device comprises at least two rockers which, together with the probe holder and the base element, form a parallelogram guide such that the probe holder is pivotable relative to the base element along a curved path without changing its orientation.

17. The machine as claimed in claim 16, comprising an adjustment spindle with a counter nut interacting therewith, which are arranged diagonally with respect to the parallelogram guide between the base element and the probe holder in order to vary a pivoting position of the probe holder.

18. The machine as claimed in claim 1,
comprising a static machine bed,
wherein the workpiece support is pivotable relative to the machine bed about a workpiece support axis between at least two positions,
wherein the at least one workpiece spindle is arranged on the pivotable workpiece support so as to be movable between a working position and a loading position,
wherein the workpiece spindle axis runs parallel to and with a spacing from the workpiece support axis, and
wherein the meshing device is arranged between the workpiece spindle axis and the workpiece support axis.

19. The machine as claimed in claim 18,
wherein the machine comprises two parallel workpiece spindles which are both arranged on the movable workpiece support and which are configured for the chucking of a workpiece and which are adapted to be driven in rotation about a workpiece spindle axis,
wherein a meshing device is assigned to each workpiece spindle,
wherein each of the meshing devices comprises a base element and a probe holder with a meshing probe for contactless operation, the base element being displaceable parallel to the workpiece spindle axis, the probe holder being connected to the base element such that the probe holder has a variable radial spacing to the workpiece spindle axis, and
wherein the meshing devices are constructed and arranged symmetrically with respect to one another.

20. The machine as claimed in claim 19, wherein the machine comprises a common first adjustment drive, for displacing the base elements of the two meshing devices simultaneously parallel to the respective workpiece spindle axis, and/or a common second adjustment drive, for effecting a simultaneous change of the radial spacing of the probe holders from the respective workpiece spindle axis.

21. A machine for machining workpieces with pre-machined teeth, comprising:
a workpiece support;
at least one workpiece spindle for the chucking of a workpiece, the workpiece spindle being arranged on the workpiece support being adapted to be driven in rotation about a workpiece spindle axis running vertically in space;
a meshing device which comprises a probe holder with a meshing probe for contactless operation, wherein the probe holder has an axially and/or radially variable position relative to the workpiece spindle axis; and
at least one adjustment drive for axially and/or radially varying the position of the probe holder relative to the workpiece spindle axis,
the adjustment drive being arranged on a counter stand of the workpiece support above the meshing device.

22. The machine as claimed in claim 21, comprising a static machine bed,
wherein the workpiece support is pivotable relative to the machine bed about a workpiece support axis between at least two positions,
wherein the at least one workpiece spindle is arranged on the pivotable workpiece support so as to be movable between a working position and a loading position,
wherein the workpiece spindle axis runs parallel to and with a spacing from the workpiece support axis, and
wherein the meshing device is arranged between the workpiece spindle axis and the workpiece support axis.

23. The machine as claimed in claim 22,
wherein the machine comprises two parallel workpiece spindles which are both arranged on the movable workpiece support and which are configured for the chucking of a workpiece and which are adapted to be driven in rotation about a workpiece spindle axis,
wherein a meshing device is assigned to each workpiece spindle,
wherein each of the meshing devices comprises a probe holder, with a meshing probe which operates in contactless fashion,
wherein each probe holder has an axially and/or radially variable position relative to the workpiece spindle axis,
wherein the at least one adjustment drive is configured to axially and/or radially vary the position of each probe holder relative to the workpiece spindle axis, and
wherein the meshing devices are constructed and arranged symmetrically with respect to one another.
